(19) United States
(12) Patent Application Publication
(10) Pub. No.: US 2010/0093323 A1
(43) Pub. Date: Apr. 15, 2010

(54) INTERACTIVE CONTACT LIST WITH EXPANDED ATTRIBUTES CREATING PERSONALITY

(76) Inventors: Jacob Warren Kimbrell, Cary, NC (US); Stephen Kight Forbes, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/248,068

(22) Filed: Oct. 9, 2008

(51) Int. Cl. H04W 4/00

(52) U.S. Cl. 455/414.2

(57) ABSTRACT

A process for analyzing contact attributes relating to a contact of a user of an electronic device and providing an actionable item based on the analyzing including providing an electronic device including control circuitry, a memory and a user interface; operating the control circuitry to obtain from the memory and analyze a plurality of contact attributes and to generate an actionable item from the analysis, in which the actionable item is a function of one or more of the plurality of contact attributes, and relates to non-schedule-based relationship between one or more of the plurality of contact attributes and current characteristics of the user, provide to a user interface cognizable signals based on the actionable item, and enable the user to take action based on the actionable item. An electronic device configured and a program containing logic to carry out the foregoing process.

### TECHNICAL FIELD OF THE INVENTION

The present invention relates to an electronic device, a program and a process for analyzing contact attributes and generating actionable items from the attributes.

### DESCRIPTION OF THE RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

Electronic devices, including portable communications devices, generally include capability of storing various attributes relating to contacts of users of the electronic devices. Devices are capable of storing a large number and variety of attributes in a database in the device memory. While these attributes are generally available for searching, the sheer number of attributes that may be stored make it difficult to control and organize the attributes, and even more difficult to obtain meaningful relationships between various combinations of the attributes. Accordingly, a need exists for an electronic device, a program and a process capable of analyzing the myriad contact attributes and generating actionable items based upon and derived from various combinations of the attributes.

### SUMMARY

To enhance functionality and versatility, an electronic device, such as a portable communication device is provided with a program and a process for analyzing contact attributes and generating actionable items from the attributes, for use, e.g., in a mobile communication device.

In one embodiment, the present invention relates to an electronic device including a user interface for receiving input to the electronic device from a user of the electronic device and for providing cognizable signals to a user; memory for storing input contact attributes relating to a contact of the user and an attribute analysis program; and control circuitry operatively coupled to the user interface and the memory; in which the attribute analysis program is executed by the control circuitry, the program causing the control circuitry (a) to receive and store in the memory a plurality of contact attributes relating to the contact input via the user interface, (b) to automatically analyze the plurality of contact attributes and to generate an actionable item from the analysis, in which the actionable item is a function of one or more of the plurality of contact attributes, and relates to a non-schedule based relationship between one or more of the plurality of contact attributes and current characteristics of the user, (c) to provide to the user interface the actionable item, and (d) to enable the user to take action via the user interface based on the actionable item.

In one embodiment, the present invention relates to a program stored on a machine readable medium, the program for analyzing contact attributes relating to a contact of a user of an electronic device and providing an actionable item based on the analyzing, the program including executable logic to (a) obtain from memory and analyze a plurality of contact attributes and to generate an actionable item from the analysis, wherein the actionable item is a function of one or more of the plurality of contact attributes, and relates to a non-schedule-based relationship between one or more of the plurality of contact attributes and current characteristics of the user, (b) provide to a user interface of the electronic device cognizable signals based on the actionable item, and (c) enable the user to take action via the user interface based on the actionable item.

In one embodiment, the present invention relates to a process for analyzing contact attributes relating to a contact of a user of an electronic device and providing an actionable item based on the analyzing including providing an electronic device including control circuitry, memory and a user interface; operating the control circuitry to (a) obtain from the memory and analyze a plurality of contact attributes input via the user interface and to generate an actionable item from the analysis, wherein the actionable item is a function of one or more of the plurality of contact attributes, and relates to a non-schedule-based relationship between one or more of the plurality of contact attributes and current characteristics of the user, (b) provide to a user interface of the electronic device cognizable signals based on the actionable item, and (c) enable the user to take action via the user interface based on the actionable item.

In any of the foregoing embodiments, the actionable item may relate to one or more of a relationship between the contact and the user, relationships between the contact and one or more other contacts, personal information of the contact, permissions granted to the contact by the user, and actions to be taken relating to communication with the contact.

In any of the foregoing embodiments, the plurality of contact attributes may be input to the memory by the user.

In any of the foregoing embodiments, the current characteristics of the user may include one or more of date, time, geographical location, schedule, and relationship between the user and the contact.

In any of the foregoing embodiments, the program and/or process may enable the user via the user interface to take action comprising one or more of contacting the contact by telephone or email, sending an SMS message to the contact, making positional information available to the contact, or preventing any of the foregoing actions.

In any of the foregoing embodiments, the process may be carried out in a mobile telephone.

Thus, the present invention provides and relates to an electronic device, a program and a process for analyzing contact attributes and generating actionable items from the attributes, for use, e.g., in a mobile communication device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic diagram illustrating an electronic device in accordance with aspects of the present invention.

FIG. 2 is a block schematic diagram illustrating an electronic device in accordance with aspects of the present invention.

FIG. 3 is a flow chart illustrating an exemplary process for entering attributes for use in accordance with embodiments of the present invention.

FIGS. 4-8 are flow diagrams illustrating exemplary programs in accordance with embodiments of the present invention.

### DETAILED DESCRIPTION

The present disclosure recognizes and provides a solution to a problem with the large amount of data including attributes relating to contacts stored in the memory of an electronic device, such as a mobile communications device, in that the data is often cumbersome and it is often difficult to seek and find particular attributes and to act upon them. While such attributes are often stored and may be “mined” for information, the user must know and remember to look, and the user must coordinate common attributes without ready assistance.

In solving this problem, the disclosed electronic device, program and process enables the user to much more effectively utilize the myriad attributes stored in the memory of the electronic device. The invention provides the functionality to the user of automatically review the attributes stored in memory for relevant information that may be of immediate or near-future usefulness to the user. This invention goes well beyond the simple reminder system that is widely available in conventional electronic devices, programs and processes. Thus, in the present invention, the attributes of interest are not schedule-based, and relate to relationships other than schedule-based information. While the attributes may relate to time, day or date (as will be described in more detail), they are not reminders of a schedule set by the user. The capabilities of the device, program and process of the present invention are described in more detail below, following a description of an exemplary electronic device in which the present invention may be implemented.

All ranges and ratio limits disclosed in the specification and claims may be combined in any manner. It is to be understood that unless specifically stated otherwise, references to “a”, “an”, and/or “the” may include one or more than one, and that reference to an item in the singular may also include the item in the plural. All combinations specified in the specification and claims may be combined in any manner.

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “electronic device” includes a portable communication device. As referred to herein, the term “portable communication device” includes portable radio communication equipment. The term “portable radio communication equipment”, which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the disclosed technology is being discussed with respect to portable communication devices, it is to be appreciated that the invention is not intended to be limited to portable communication devices, and can be applied to any type of handheld mobile electronic equipment having a touch-sensitive input device.

In the present application, the invention is described primarily in the context of a mobile telephone. However, it will be appreciated that the invention is not intended to be limited to a mobile telephone and may be any type of electronic device. For instance, aspects of the invention may be applied to portable items of electronic equipment that do not include radio communications functionality, such as a PDA or a multimedia player.

In the context of the illustrated embodiments, the portable communication device is sometimes referred to as a mobile telephone or a mobile phone. The description and illustrations of the mobile telephone, however, are intended to serve as a non-limiting exemplary environment for the inventive concepts described herein, and it will be appreciated that the invention is not intended to be limited to a mobile telephone, but rather can be any type of electronic device.

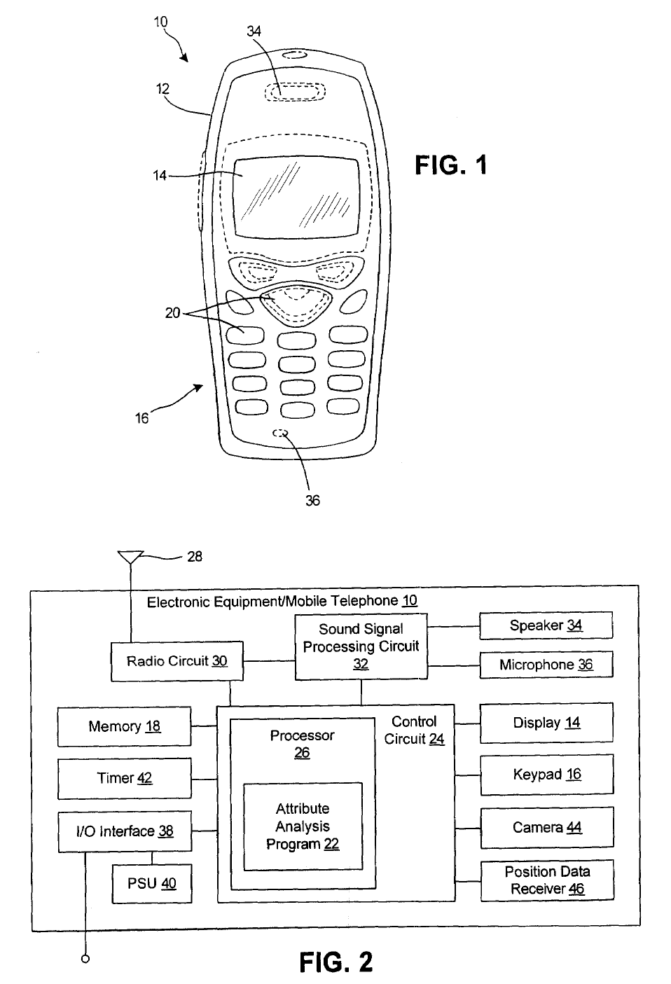

Referring initially to FIG. 1, an electronic device 10 is shown in accordance with the present invention. The electronic device includes an incident record organization function that is configured to organize incident records by location information associated with the incident records. It will be appreciated that the incident record organization function may be embodied as executable code that may be resident in the electronic device 10.

The illustrated electronic device 10 is a portable device. Due to the basic nature of portable devices, the electronic device 10 is operable when taken from location to location by a user. Hence, there is not only a relationship between each incident and when the incident took place, but there also is a relationship between each incident and where the incident took place. One or both of these relationships will be used by the incident record organization function to organize incident records and assist the user in retrieving one or more particular incident records of interest, as will be explained in greater detail below.

The electronic device in the exemplary embodiment is a mobile telephone and will be referred to as the mobile telephone 10. The mobile telephone 10 is shown as having a “brick,” “block” or “stick” form factor type housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of an attribute analysis program 22 according to the present invention, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, a buffer, a flash memory, a hard drive, a removable media, a volatile memory and/or a non-volatile memory. In addition, the processing device 26 executes code in accordance with the present invention in order to carry out the attribute analysis program 22. The attribute analysis program 22 is described in more detail below. In accordance with the present invention, the attribute analysis program is stored in a machine readable memory, e.g., a ROM, RAM, flash memory, magnetic tape, optical storage medium, etc., shown in FIG. 1 as the memory 18. When executed, the attribute analysis program causes the electronic device to carry out the functions described herein.

It will be apparent to a person having ordinary skill in the art of computer programming, and specifically in applications programming for mobile telephones, how to program a mobile telephone 10 to operate and carry out the functions described herein. Accordingly, details as to the specific programming code have been left out for sake of brevity. Also, while the attribute analysis program 22 is executed by the processing device 26 in accordance with the preferred embodiment of the invention, such functionality could also be carried out via dedicated hardware, firmware, software, or combinations thereof, without departing from the scope of the invention. The attribute database is created, stored and maintained in memory the processor in accordance with conventional control database techniques, with the exception of the additional attribute analysis programs and processes in accordance with the invention described herein.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The mobile telephone 10 further includes a sound signal processing circuit 32 for processing the audio signal transmitted by/received from the radio circuit 28. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The mobile telephone 10 further includes an I/O interface 38. The I/O interface 38 may be in the form of typical mobile telephone I/O interfaces, such as a multi-element connector at the base of the mobile telephone 10. As is typical, the I/O interface 38 may be used to couple the mobile telephone 10 to a battery charger to charge a power supply unit (PSU) 40 within the mobile telephone 10. In addition, or in the alternative, the I/O interface 38 may serve to connect the mobile telephone 10 to a wired personal hands-free adaptor (not shown) or a local wireless interface (e.g., the I/O interface may include or be connected to local wireless adapter such as a Bluetooth adaptor for use with a Bluetooth-based hands-free adaptor or other device). Further, the I/O interface 38 may serve to connect the mobile telephone 10 to a personal computer or other device via a data cable or wireless link, etc.

The mobile telephone 10 may also include a timer 42 for carrying out timing functions. Such functions may include timing the durations of calls, generating the content of time and date stamps, etc.

The mobile telephone 10 may be configured to operate in a communications system (not illustrated). The system can include a server or servers for managing calls placed by and destined to the mobile telephone 10, transmitting content to the mobile telephone 10 and carrying out any other support functions. The server communicates with the mobile telephone 10 via a network and a transmission medium. The transmission medium may be any appropriate device or assembly, including, for example, a communications tower, another mobile telephone, a wireless access point, a satellite, etc. Portions of the network may include wireless transmission pathways.

The mobile telephone 10 may include a camera 44 for taking digital pictures. Image files corresponding to the pictures may be stored in the memory 18.

The mobile telephone 10 also may include a position data receiver 46, such as a global positioning satellite (GPS) receiver, Galileo satellite system receiver or the like.

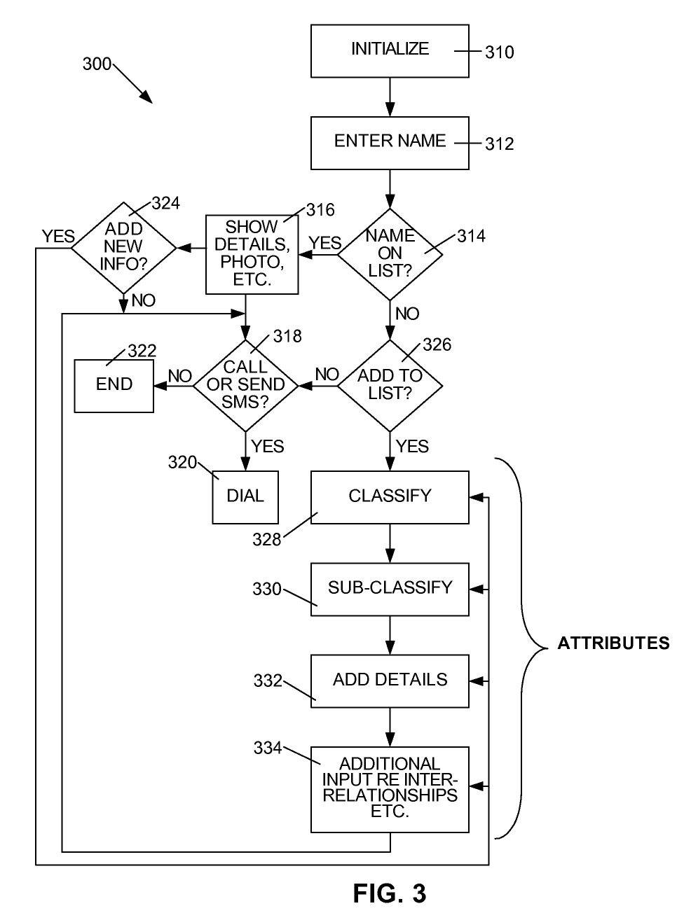

Referring to FIG. 3, which is a flow chart illustrating an exemplary process 300 for entering attributes for use in accordance with embodiments of the present invention, entry of attributes is shown, together with use of an electronic device such as a mobile communications device. As shown in FIG. 3, the electronic device is first initialized, in step 310, e.g., a power switch is activated. The user may then enter the name or first few letters of the name of a contact, in step 312. In step 314, the program automatically searches the database for the name. If in step 314 the program recognizes the name as one on the list of contacts, the program can show details of the contact, such as phone number, last contact, photograph if same is stored in the memory of the device, and any other details, as shown in step 316. The program may at this point prompt the user, e.g., visually via the display 14, audibly via the speaker 34, etc., as shown in step 318 to call or otherwise send a communication to the contact, such as by SMS. If the user desires, the device may then carry out the indicated function, e.g., by dialing the contact's phone number or transmitting a text message to the contact, as shown in step 320. If the user does not so desire, the program terminates, as shown in step 322. At the step 316, the program automatically prompts the user to add any new information and/or to update the existing attributes for the contact, as shown in step 324. If the user so desires, any new information may be added according to the steps to be described below for non-recognized contacts.

If in the step 314 the program does not recognize the name as one on the list of contacts, the program can prompt the user whether to add the name and attributes of the non-recognized contact to the user's contact list, as shown in step 326. If the user does not elect to enter the name and attributes, then the program may prompt the user whether to phone or send a text message to the non-recognized contact, in the steps 318 and 320 or 322, proceeding as described above.

If the user elects to enter the name and attributes of the non-recognized contact, the program then provides for the user to enter attributes relating to the contact. As shown in FIG. 3, the entry of the attributes may proceed through several steps 328-334 (described below), which may include increasingly detailed information.

As illustrated in FIG. 3, in entering the attributes, the user is first prompted to classify the contact, in step 328, by entering classification information, such as whether the contact is family, friend, co-worker, social acquaintance, business acquaintance, etc. Next, in step 330, the user is prompted to sub-classify the contact, such as, for example, by indicating whether the family member is mother, father, sister, brother, aunt, uncle, grandparent, offspring, etc. In the friend category, the sub-classifying may specify, for example, whether the contact is a neighbor, school friend, social friend, etc. In the co-worker category, the sub-classifying may specify, for example, whether the contact is a peer, a supervisor, a supervisee, etc. In the business acquaintance, the sub-classifying may specify, for example, whether the contact is a customer, vendor, competitor, etc. As will be readily recognized, a wide variety of classifications and sub-classifications may be included.

Following the sub-classifying in the step 330, the user is automatically prompted, as shown in step 332, to enter additional details about the contact. These details may include any usual details of interest, such as physical address, mailing address, email address, telephone number(s), work address, etc.

Following the entry of such additional details in the step 332, the user may be prompted, as shown in step 334, to enter additional information relating, for example, to inter-relationships between various of the contacts that are not readily apparent from the classifying or sub-classifying. For example, the user may be a member of a sporting group, e.g., a bowling team, a group of bicyclists or sporting event buddies, that includes people classified as relatives, friends and co-workers.

All of the foregoing information entered by the user in the classifying, sub-classifying, adding details and adding other inter-relationships constitute attributes in accordance with the present invention. Attributes according to the present invention include the foregoing, but are not limited those specifically enumerated.

As further indicated in FIG. 3, when the name of a contact is entered and is indicated by the program as having been found on the list of users, the program may also provide for the user to add any new or additional attributes, which may include addition of any of the foregoing classifying, sub-classifying, details and other inter-relationships that constitute attributes in accordance with the present invention.

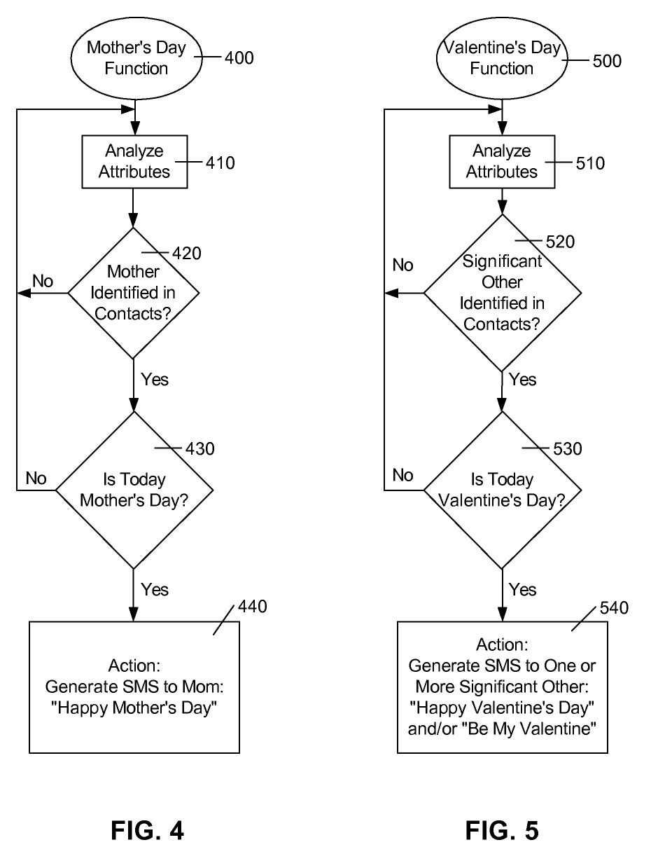

FIGS. 4-8 are flow diagrams illustrating exemplary programs in accordance with embodiments of the present invention. In each of the FIGS. 4-7, a particular function that is part of the attribute analysis program 22 is carried out with respect to selected attributes. Each of these is exemplary and not intended to be limiting of the scope of the invention. In each of the FIGS. 4-8, the control circuitry 24 and/or the processor 26 is operated carry out the attribute analysis program 22 to obtain from the memory 18 and analyze a plurality of contact attributes and to generate an actionable item from the analysis, in which the actionable item is a function of one or more of the plurality of contact attributes, and relates to a non-schedule-based relationship between one or more of the plurality of contact attributes and current characteristics of the user, to provide to a user interface, e.g., one or both of the speaker 34 or the display 14 of the electronic device 10 cognizable signals based on the actionable item, and to enable the user to take action via the user interface, e.g., the keypad 16, based on the actionable item.

FIG. 4 illustrates a “Mother's Day” function 400 that may be carried out in accordance with an embodiment of the present invention. In this function, the contact attributes stored in the memory are analyzed in step 410, in search of a contact having an attribute identified as “mother” stored in the memory 18. If in the step 420 the analysis determines the presence of “mother”, in step 430 the function next queries whether today, i.e., the current date, is Mother's Day. If both conditions are met in the steps 420 and 430, then, as shown in step 440, the user is notified via the user interface by one or more signals indicating that today is Mother's Day and enabling the user to send an SMS to the user's mother, or some other mother, with a “Happy Mother's Day” greeting, via the mobile device 10. Alternatively, upon both conditions being met in the steps 420 and 430, the user could be prompted or enable to telephone the mother, or the user could be prompted to visit the mother and, possibly, provided with a reminder that the user is located in a place from which the user could visit “mother”. Alternatively, the function could operate to identify Mother's Day prior to the actual day, to provide the user with the option or suggestion to order a gift or flowers in time to be delivered on Mother's Day. In this embodiment, the function could be changed such that the query in the step 430 becomes “is Mother's Day coming within X days?”, with the resulting prompt to the user via the user interface, e.g., the display 14 or the speaker 34, indicating this. As shown in FIG. 4, if either of the inquiries in the steps 420 and 430 in the analysis is negative, then the function returns to the beginning and is reset, for example, to run the analysis beginning with the step 410 once each day.

FIG. 5 illustrates a “Valentine's Day” function 500 that may be carried out in accordance with another embodiment of the present invention. In this function, the contact attributes stored in the memory are analyzed in step 510, in search of a contact having an attribute identified as “significant other” or “girlfriend”, or “boyfriend” or “spouse”, etc. If in step 520 the analysis determines the presence of one or more such contact having the appropriate attribute, in the step 530, the function next queries whether today, i.e., the current date, is Valentine's Day. If both conditions are met in the steps 520 and 530, then the user is notified via the user interface by one or more signals, e.g., via the display 14 or the speaker 34, indicating that today is Valentine's Day and enabling the user via step 540 to send an SMS to one or more of the user's significant others, with a “Happy Valentine's Day” greeting via the mobile device 10. Alternatively, upon both conditions being met in the steps 520 and 530, the user could be prompted or enabled in the step 540 to telephone the one or more significant other, or in the step 540 the user could be prompted to visit the one or more significant other and, possibly also in the step 540, be provided with a reminder that the user is located in a place from which the user could visit the significant other(s). Alternatively, the function 500 could operate to identify Valentine's Day prior to the actual day, to provide the user with the possibility of ordering a gift or flowers in time to be delivered on Valentine's Day. The function 500 could be changed such that the query in the step 530 becomes “is Valentine's Day coming within X days?”, with the resulting prompt to the user via the user interface in the step 540 indicating this. As shown in FIG. 5, if either of the inquiries in steps 520 and 530 of the analysis is negative, then the function 500 returns to the beginning and is reset, for example, to run the analysis beginning with the step 510 once each day.

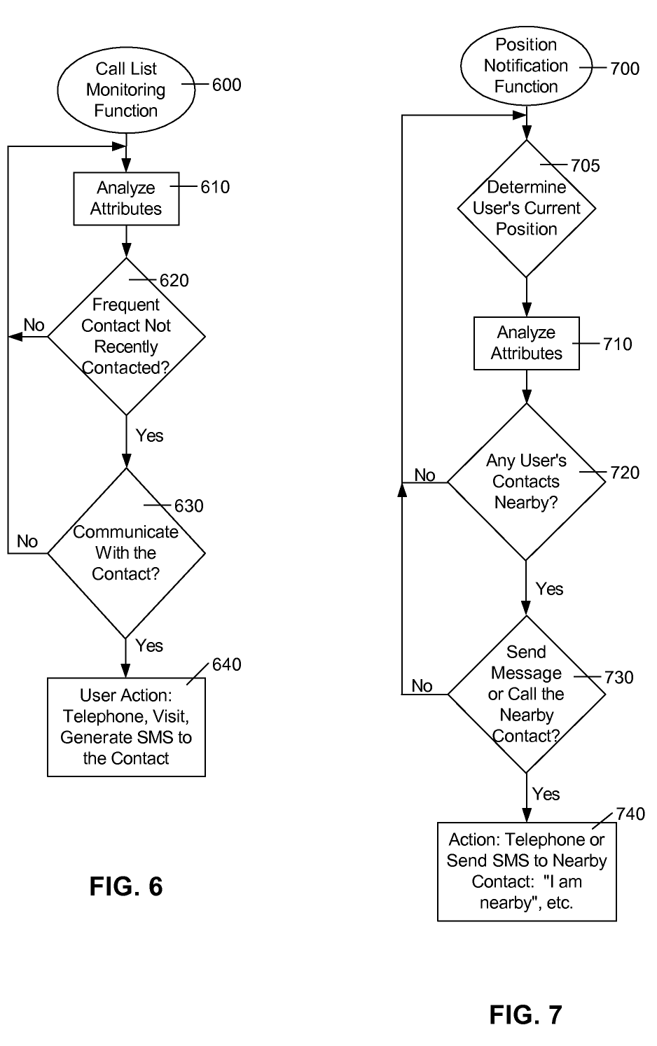

FIG. 6 illustrates a “Call List Monitoring” function 600 that may be carried out in accordance with another embodiment of the present invention. In this function, the contact attributes stored in the memory are analyzed in step 610, in search of a contact having an attribute identified as a frequent contact not recently contacted. If in step 620 the analysis locates one of the user's frequent contacts, and additionally in step 620 determines from a call log stored in the memory 18 that the user has not contacted the thus-identified frequent contact for a time period longer than the usual interval between contacts, in step 630 the function then provides the user with a prompt via the user interface in response to which the user may choose to telephone or otherwise communicate with that frequent contact, as shown in step 640. In this embodiment, the user may be prompted or enabled to include as an attribute, and store in the memory 18, that the particular contact of interest is to be designated a “frequent contact”, a call log stored for each such frequent contact, and a time interval set as “usual”, i.e., a customary time between contacts. This usual or customary time may be set as desired by the user, and new information added at any time. In this embodiment, the memory 18 (or other memory) stores these attributes, for one or more frequent contacts, and upon determining that the particular frequent contact has not actually communicated recently with the user (either by the user or from the contact), prompts and enables the user to initiate such communication, at the user's discretion in the step 640. The communication thus initiated may include any form of communication, e.g., telephone call, SMS, personal visit, etc. As shown in FIG. 6, if either of the inquiries in the steps 620 and 630 of the analysis is negative, then the function returns to the beginning and is reset, for example, for the function 600 to run once each day from step 610, or once each pre-determined time period.

FIG. 7 illustrates a “Position Notification” function 700 that may be carried out in accordance with an embodiment of the present invention. In this function, the contact attributes stored in the memory are analyzed in step 710, in search of a contact having an attribute identified as the contact's location, for example, the contact's place of business, home, or other place of interest, such as health club or social gathering place, in relation or proximity to the user's current location. In this embodiment, the electronic device may include, for example, a position data receiver 46, such as a GPS tracking device or a cellular tracking device, from which the user's position can be determined on a continuous or intermittent basis, as desired, in relation to the known position of the user's contacts or other database of contacts. The other database of contacts may be a publicly available directory, including location information. In accordance with this function, a first step 705, as shown in FIG. 7, is to determine the user's current position. This determination could be carried out on a continuous or intermittent basis, or only at the user's instruction. Once the user's position is determined in the step 705, then the attribute analysis program is carried out starting from the step 710, in which the function in step 720 searches for contacts having a location attribute within a desired range of distance and/or time. For example, the location attribute might be limited to searching for contacts within a set distance, a number of city blocks, an interval of time necessary to reach the contact's position by foot, bicycle, public transport, automobile, etc. As shown in FIG. 7, if any of the user's contacts are within the desired range, the user may be prompted in a step 730and enabled to take some action based on the proximity of the user to the contact, such as a telephone call or an SMS to let the contact know that the user is in the vicinity as shown in step 740. As shown in FIG. 7, if either of the inquiries in the step 720 or 730 the analysis is negative, then the function 700 returns to the beginning and is reset, for example, to run again, for example, when the user's position changes, as determined in step 705.

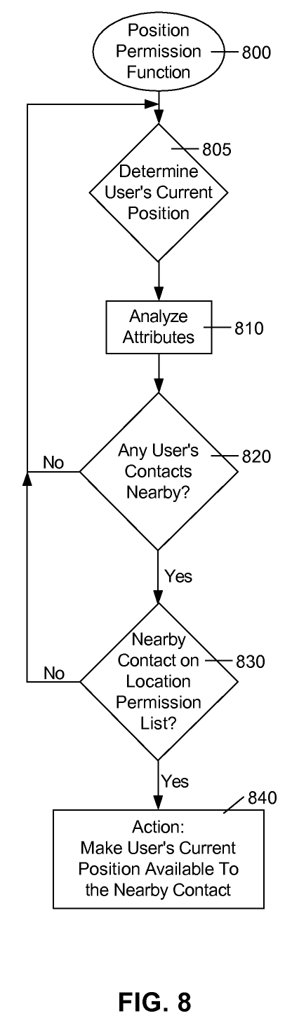

FIG. 8 is similar to FIG. 7, but illustrates a variation on the Position Notification function 700, which may be referred to as a “Position Permission” function 800. In this embodiment, the function 800 follows the same initial steps 805, 810 and 820, i.e., through determination of the user's position, analyzing attributes relating to location of a contact, and whether any of the user's contacts are nearby relative to the current position of the user. However, in step 830, instead of (or, alternatively, together and in parallel with) directly communicating with the contact, as in the step 730 of the embodiment illustrated in FIG. 7, in the Position Permission function 800, the function in step 840 prompts the user to allow the contact to learn that the user is in the vicinity of the contact. This is similar to the embodiment of FIG. 7, but is passive, in that by making the user's position available to a search by the contact, it allows the contact to determine the presence of the user, in case the contact is seeking such information. Thus, the user in this embodiment makes himself “visible” or “detectable” to the contact who is nearby. This more subtle approach might be used in a situation where the user does not want to directly send a communication to the contact, but instead is interested in letting the contact “find out” that the user is both in the vicinity and willing to be contacted. As shown in FIG. 8, if either of the inquiries in the step 820 or 830 the analysis is negative, then the function 800 returns to the beginning and is reset, for example, to run again, for example, when the user's position changes, as determined in step 805.

Although certain embodiments have been shown and described, it is understood that equivalents and modifications falling within the scope of the appended claims will occur to others who are skilled in the art upon the reading and understanding of this specification. Furthermore, it is to be understood that every possible combination of any features described herein is within the scope of the present disclosure. That is, while every possible permutation of features and details has not been exhaustively described, the skilled person will readily recognize that the specifically described features of one embodiment may be applied to any other embodiment described herein.

1. An electronic device comprising:
a user interface for receiving input to the electronic device from a user of the electronic device and for providing cognizable signals to a user;
memory for storing input contact attributes relating to a contact of the user and an attribute analysis program; and
control circuitry operatively coupled to the user interface and the memory;
wherein the attribute analysis program is executed by the control circuitry, the program causing the control circuitry:
to receive and store in the memory a plurality of contact attributes relating to the contact input via the user interface,
to automatically analyze the plurality of contact attributes and to generate an actionable item from the analysis, wherein the actionable item is a function of one or more of the plurality of contact attributes, and relates to a non-schedule based relationship between one or more of the plurality of contact attributes and current characteristics of the user,
to provide to the user interface the actionable item, and
to enable the user to take action via the user interface based on the actionable item.

2. The electronic device of claim 1 wherein the actionable item relates to one or more of a relationship between the contact and the user, relationships between the contact and one or more other contacts, personal information of the contact, permissions granted to the contact by the user, and actions to be taken relating to communication with the contact.

3. The electronic device of claim 1 wherein the plurality of contact attributes are input to the memory by the user.

4. The electronic device of claim 1 wherein the current characteristics of the user include one or more of date, time, geographical location, schedule, and relationship between the user and the contact.

5. The electronic device of claim 1 wherein the attribute analysis program comprises logic obtained from logic circuitry, software, firmware or a combination of any two or more thereof.

6. The electronic device of claim 1 wherein the action taken by the user via the user interface comprises one or more of communicating with the contact by telephone or email, sending an SMS message to the contact, making geographical location information available to the contact, or preventing any of the foregoing actions.

7. The electronic device of claim 1 wherein the device is a mobile telephone.

8. A program stored on a machine readable medium, the program for analyzing contact attributes relating to a contact of a user of an electronic device and providing an actionable item based on the analyzing, the program comprising executable logic to:
obtain from memory and analyze a plurality of contact attributes and to generate an actionable item from the analysis, wherein the actionable item is a function of one or more of the plurality of contact attributes, and relates to a non-schedule-based relationship between one or more of the plurality of contact attributes and current characteristics of the user,
provide to a user interface of the electronic device cognizable signals based on the actionable item, and
enable the user to take action via the user interface based on the actionable item.

9. The program of claim 8 wherein the actionable item relates to one or more of a relationship between the contact and the user, relationships between the contact and one or more other contacts, personal information of the contact, permissions granted to the contact by the user, and actions to be taken relating to communication with the contact.

10. The program of claim 8 wherein the plurality of contact attributes are input to the memory by the user.

11. The program of claim 8 wherein the current characteristics of the user include one or more of date, time, geographical location, schedule, and relationship between the user and the contact.

12. The program of claim 8 wherein the executable logic is obtained from logic circuitry, software, firmware or a combination of any two or more thereof.

13. The program of claim 8 wherein the executable logic enables the user via the user interface to take action comprising one or more of contacting the contact by telephone or email, sending an SMS message to the contact, making positional information available to the contact, or preventing any of the foregoing actions.

14. The program of claim 8 wherein the executable logic is executed in a mobile telephone.

15. A process for analyzing contact attributes relating to a contact of a user of an electronic device and providing an actionable item based on the analyzing comprising:
providing an electronic device including control circuitry, memory and a user interface;
operating the control circuitry to:
obtain from the memory and analyze a plurality of contact attributes input via the user interface and to generate an actionable item from the analysis, wherein the actionable item is a function of one or more of the plurality of contact attributes, and relates to a non-schedule-based relationship between one or more of the plurality of contact attributes and current characteristics of the user,
provide to a user interface of the electronic device cognizable signals based on the actionable item, and
enable the user to take action via the user interface based on the actionable item.

16. The process of claim 15 wherein the actionable item relates to one or more of a relationship between the contact and the user, relationships between the contact and one or more other contacts, personal information of the contact, permissions granted to the contact by the user, and actions to be taken relating to communication with the contact.

17. The program of claim 15 wherein the plurality of contact attributes are input to the memory by the user.

18. The process of claim 15 wherein the current characteristics of the user include one or more of date, time, geographical location, schedule, and relationship between the user and the contact.

19. The process of claim 15 further comprising enabling the user via the user interface to take action comprising one or more of contacting the contact by telephone or email, sending an SMS message to the contact, making positional information available to the contact, or preventing any of the foregoing actions.

20. The process of claim 15 wherein the process is carried out in a mobile telephone.
